(19) United States
(12) Patent Application Publication
(10) Pub. No.: US 2024/0244168 A1
(43) Pub. Date: Jul. 18, 2024

(54) DISPLAY METHOD, INFORMATION PROCESSING APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventor: Fumitaka KATO, Matsumoto-Shi (JP)

(21) Appl. No.: 18/411,084

(22) Filed: Jan. 12, 2024

(30) Foreign Application Priority Data
Jan. 13, 2023 (JP) 2023-003590

(51) Int. Cl. H04N 9/31

(52) U.S. Cl. CPC H04N 9/3185; H04N 9/3194

(57) ABSTRACT

A display method including displaying a projection image on a projection surface by controlling a projection apparatus, displaying a pointer image located at a corner of the projection image by controlling the projection apparatus, performing first correction of correcting the shape of the projection image by changing the position of the corner of the projection image based on a user's operation of moving the pointer image, and displaying a guide image indicating the positions where one or more markers are put by the user by controlling the projection apparatus at a predetermined position on the projection surface with respect to the position of the pointer image moved based on the user's operation.

The present application is based on, and claims priority from JP Application Serial Number 2023-003590, filed Jan. 13, 2023, the disclosure of which is hereby incorporated by reference herein in its entirety.

### BACKGROUND

### 1. Technical Field

The present disclosure relates to a display method, an information processing apparatus, and a non-transitory computer-readable storage medium storing a program.

### 2. Related Art

There is a developed technology for correcting the position and shape of an image displayed on a projection surface by an apparatus such as a projector with the aid of a captured image produced by capturing an image of a marker placed on the projection surface. For example, JP-A-2022-092132 discloses a detection apparatus including a display section, an imaging section, an image acquisition section that acquires a captured image produced by causing the imaging section to capture an image of a target region in which a plurality of markers are placed, and a controller that superimposes a guide image corresponding to the number of makers placed in the target region or a positional relationship among the plurality of markers on the captured image produced by the imaging section and causes the display section to display the superimposed image. The imaging section captures an image of the markers placed in the target region, and the detection apparatus superimposes the guide image on the image output from the imaging section and causes the display section to display the superimposed image. A user captures images of the markers with the aid of the guide image as a guide, and can place the images showing the markers contained in the captured image at proper positions. The detection apparatus can detect the images showing the markers from the captured image at high speed and with high accuracy.

JP-A-2022-092132 is an example of the related art.

To capture images of the markers with the detection apparatus, the user needs to adjust the direction in which the imaging section is oriented based on the guide image. For example, depending on the user, such as an elderly or a child, it is not easy to properly adjust the direction in which the imaging section is oriented, so that the captured image may not be acquired properly.

### SUMMARY

A display method according to an aspect of the present disclosure includes displaying a projection image on a projection surface by controlling a projection apparatus, displaying a pointer image located at a corner of the projection image by controlling the projection apparatus, performing first correction of correcting a shape of the projection image by changing a position of the corner of the projection image based on a user's operation of moving the pointer image, and displaying a guide image indicating positions where one or more markers are put by the user by controlling the projection apparatus at a predetermined position on the projection surface with respect to the position of the pointer image moved based on the user's operation.

An information processing apparatus according to another aspect of the present disclosure includes a processing apparatus, and the processing apparatus controls a projection apparatus to cause the projection apparatus to display a projection image on a projection surface, controls the projection apparatus to cause the projection apparatus to display a pointer image located at a corner of the projection image, performs first correction of correcting a shape of the projection image by changing a position of the corner of the projection image based on a user's operation of moving the pointer image, and controls the projection apparatus to cause the projection apparatus to display a guide image indicating positions where one or more markers are put by the user at a predetermined position on the projection surface with respect to a position of the pointer image moved based on the user's operation.

A non-transitory computer-readable storage medium storing a program according to another aspect of the present disclosure causes a processing apparatus to control a projection apparatus to cause the projection apparatus to display a projection image on a projection surface, control a projection apparatus to cause the projection apparatus to display a pointer image located at a corner of the projection image, perform first correction of correcting a shape of the projection image by changing a position of the corner of the projection image based on a user's operation of moving the pointer image, and control the projection apparatus to cause the projection apparatus to display a guide image indicating positions where one or more markers are put by the user at a predetermined position on the projection surface with respect to a position of the pointer image moved based on the user's operation.

### BRIEF DESCRIPTION OF THE DRAWINGS

FIG. 1 is a diagrammatic view showing how a pointer image is displayed.

FIG. 2 is a diagrammatic view illustrating the configuration of the pointer image.

FIG. 3 is a diagrammatic view showing how a guide image is displayed.

FIG. 4 is a block diagram showing the configuration of a projector according to an embodiment.

FIG. 5 is a block diagram showing the configuration of a storage apparatus according to the embodiment.

FIG. 6 is a diagrammatic view illustrating a captured image.

FIG. 7 is a diagrammatic view illustrating another captured image.

FIG. 8 is a flowchart illustrating the action of the projector according to the embodiment.

### DESCRIPTION OF EMBODIMENTS

A preferable embodiment according to the present disclosure will be described below with reference to the accompanying drawings. In the drawings, the dimensions and scale of each portion differ from actual values in some cases, and some of the portions are diagrammatically drawn for ease of understanding. The scope of the present disclosure is, however, not limited to the embodiment unless particular restrictions on the present disclosure are made in the following description.

### 1. Embodiment

A display method, an information processing apparatus, and a program according to the embodiment of the present disclosure will be described by showing a projector by way of example that displays a guide image indicating a marker put position on a projection surface with respect to the position of a pointer image located at a corner of a projection image. The projector according to the embodiment corrects the shape of the projection image by changing the position of the corner of the projection image based on a user's operation of moving the pointer image. The projector according to the embodiment further corrects the shape of the projection image and the position where the projection image is displayed based on a captured image produced by capturing an image of a range containing the marker put to the position indicated by the guide image.

### 1.1. Overview of Projector

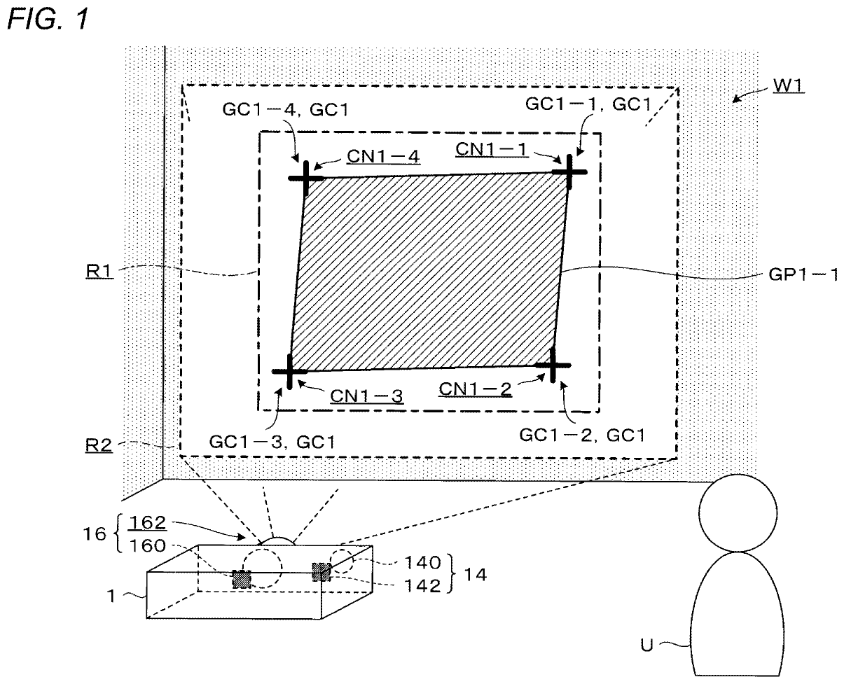

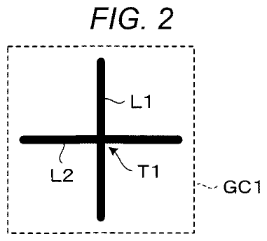

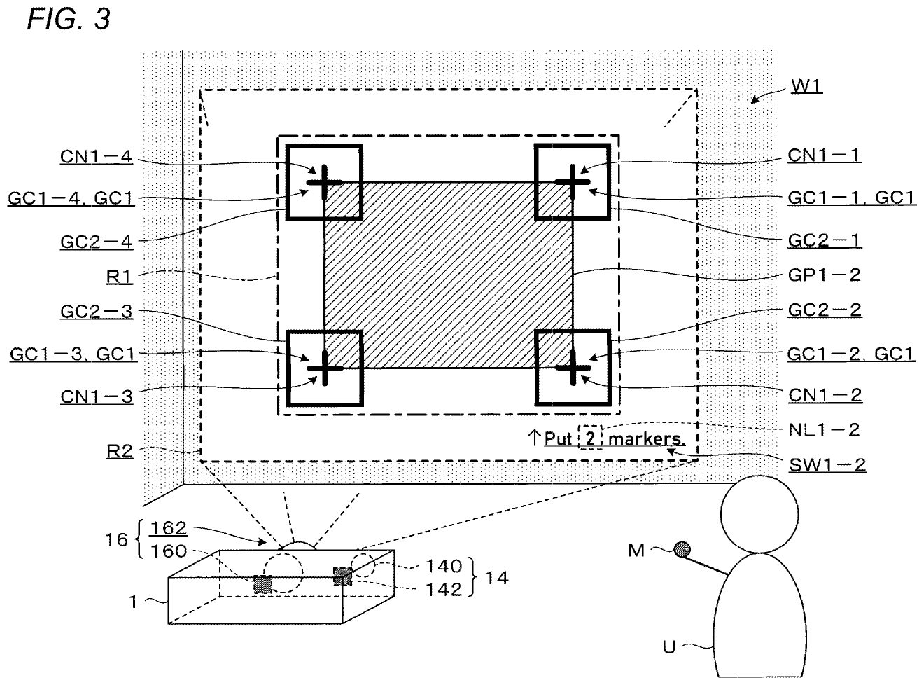

An overview of a projector 1 according to the embodiment will be described below with reference to FIGS. 1 to 3. FIG. 1 is a diagrammatic view showing how a pointer image GC1 is displayed. FIG. 2 is a diagrammatic view illustrating the configuration of the pointer image GC1. FIG. 3 is a diagrammatic view showing how a guide image GC2 is displayed.

The projector 1 includes an imaging apparatus 14, which captures an image of a range containing a predetermined region of the projection surface, and a projection apparatus 16, which projects projection light onto the projection surface. The imaging apparatus 14 includes an imaging lens 142, which focuses light, and an imaging device 140, which converts the light focused by the imaging lens 142 into an electric signal to generate a captured image. The imaging device 140 includes a plurality of pixels. The projection apparatus 16 includes a light source that is not shown, a light modulator 160, which modulates the light emitted from the light source into the projection light that displays a projection image on the projection surface, a projection lens 162, which projects the projection light modulated by the light modulator 160 onto the projection surface. The light modulator 160 includes a plurality of pixels. The projector 1 controls the projection apparatus 16 to cause it to display an image on the projection surface. In the present embodiment, the projector 1 controls the projection apparatus 16 to cause it to display a projection image GP1 on a wall surface W1, which is the projection surface. The projection surface is not limited to the wall surface W1, and may instead be a screen.

The following description will be made with reference to FIG. 1. The projector 1 displays a projection image GP1-1 by projecting the projection light onto a region R2 of the wall surface W1. The projection image GP1-1 is an example of the projection image GP1. The projection image GP1-1 is displayed in a region R1 of the wall surface W1. The region R1 falls within the region R2. The region R1 may for example, be a region that is part of a screen installed on the wall surface W1 and is surrounded by the frame of the screen, or a region that is part of the wall surface W1 and is surrounded by a frame line drawn at part of the surface of the wall surface W1.

The projection image GP1 has corners CN1-1, CN1-2, CN1-3, and CN1-4. Note that, the corners CN1-1 to CN1-4 may be referred to as a “corner CN1” when the corners CN1-1 and CN1-4 are not distinguished from each other.

The projector 1 further controls the projection apparatus 16 to cause it to display a pointer image GC1-1, a pointer image GC1-2, a pointer image GC1-3, and a pointer image GC1-4 on the wall surface W1. The pointer images GC1-1 to GC1-4 each have, for example, the shape of a cross having two straight lines that intersect with each other. The pointer image GC1-1 is located at the corner CN1-1. The pointer image GC1-2 is located at the corner CN1-2. The pointer image GC1-3 is located at the corner CN1-3. The pointer image GC1-4 is located at the corner CN1-4. In other words, the pointer image GC1-1 indicates the position of the corner CN1-1. The pointer image GC1-2 indicates the position of the corner CN1-2. The pointer image GC1-3 indicates the position of the corner CN1-3. The pointer image GC1-4 indicates the position of the corner CN1-4. Note that the pointer images GC1-1 to GC1-4 may be referred to as a “pointer image GC1” when the pointer images GC1-1 to GC1-4 are not distinguished from each other.

The following description will be made with reference to FIG. 2. The pointer image GC1-1 has lines L1 and L2. In FIG. 2, the lines L1 and L2 are drawn in the form of straight lines, but not necessarily. The lines L1 and L2 may instead be curved lines. Still instead, one of the lines L1 and L2 may be a straight line, and the other one of the lines L1 and L2 may be a curved line. The lines L1 and L2 intersect with each other at an intersection T1. That is, the pointer image GC1-1 has the intersection T1.

The following description will be made with reference to FIG. 1 again. A user U changes the position of the corner CN1, which is a corner of the projection image GP1 and indicated by the pointer image GC1, by performing the operation of moving the pointer image GC1. For example, the user U changes the position of the corner CN1-2 indicated by the pointer image GC1-2 by performing the operation of moving the pointer image GC1-2. The projector 1 corrects the shape of the projection image GP1 by changing the position of the corner CN1 of the projection image GP1 based on the user U's operation of moving the pointer image GC1. For example, the projector 1 corrects the shape of the projection image GP1 by changing the position of the corner CN1-2 of the projection image GP1 based on the user U's operation of moving the pointer image GC1-2. For example, the shape of the projection image GP1 is so modified by the user U that the modified shape is approximately similar to the screen frame. That is, when the screen frame has a rectangular shape, the projection image GP1 is so shaped based on the user U's operation that the projection image GP1 also has a rectangular shape. Note that correcting the projection image based on the user U's operation may be referred to as “first correction”. Correcting the projection image based on the captured image may be referred to as “second correction”.

The following description will be made with reference to FIG. 3. The projector 1 controls the projection apparatus 16 to cause it to display a projection image GP1-2. The projection image GP1-2 is another example of the projection image GP1. Specifically, the projector 1 updates the image displayed on the wall surface W1 from the projection image GP1-1 to the projection image GP1-2 by performing the first correction based on the user U's operation. That is, the projection image GP1-2 is the projection image GP1 after corrected by the first correction. On the other hand, the projection image GP1-1 is the projection image GP1 before corrected yet by the first correction. In FIG. 3, the pointer images GC1-1 to GC1-4 are located at positions moved based on the user U's operation relating to the first correction. The projection image GP1-2 is displayed in the region R1.

The projector 1 captures an image of a range containing the region R1, where the projection image GP1-2 is displayed, by controlling the imaging apparatus 14. The projector 1 performs image processing on the captured image showing the result of the capture of an image of the range containing the region R1, where the projection image GP1-2 is displayed, to detect a plurality of points corresponding to the four corners that the image showing the region R1 and contained in the captured image has.

When something that explicitly shows the user U the position of the region R1 is present on the wall surface W1, such as a boundary line between the interior and exterior of the region R1 or marks indicating the positions of the four corners of the region R1, the position of the image showing the region R1 is explicitly shown in the captured image showing the result of capture of the range containing the region R1. Therefore, when image processing is performed on the captured image, a plurality of points corresponding to the four corners that the image showing the region R1 and contained in the captured image has are detected.

On the other hand, when there is no such a thing that explicitly shows the user U the position of the region R1 on the wall surface W1, the position of the image showing the region R1 is not explicitly shown in the captured image showing the result of capture of the range containing the region R1, as shown in FIG. 3. Therefore, when image processing is performed on the captured image, a plurality of points corresponding to the four corners that the image showing the region R1 and contained in the captured image has may not be detected. It is assumed in the description that a plurality of points corresponding to the four corners that the image showing the region R1 and contained in the captured image has are not detected by the image processing.

When there is a corner at which no point has been detected by the image processing out of the four corners that the image showing the region R1 and contained in the captured image has, the projector 1 displays a guide image corresponding to the pointer image GC1 indicating the position of the corner CN1 of the projection image GP1, which corresponds to the corner at which no point has been detected. That is, the projector 1 controls the projection apparatus 16 to cause it to display a guide image GC2-1, a guide image GC2-2, a guide image GC2-3, and a guide image GC2-4 on the wall surface W1. The guide images GC2-1 to GC2-4 are images showing the positions where one or more markers M are put by the user U. That is, the user U can grasp the positions where the plurality of markers M should be put by checking the guide images GC2-1 to GC2-4. In the present embodiment, the guide images GC2-1 to GC2-4 are each an image having a rectangular frame line. Note that, the guide images GC2-1 to GC2-4 may be referred to as a “guide image GC2” when the guide images GC2-1 to GC2-4 are not distinguished from each other.

The guide image GC2-1 is displayed at a predetermined position with respect to the position of the pointer image GC1-1. Specifically, the guide image GC2-1 is so displayed that the intersection T1 shown in the pointer image GC1-1 is the center of the guide image GC2-1. That is, the guide image GC2-1 surrounds the intersection T1 shown in the pointer image GC1-1. The user U can grasp the positions where the one or more markers M corresponding to the position of the corner CN1-1 indicated by the pointer image GC1-1 are put by checking the guide image GC2-1.

The guide image GC2-2 is displayed at a predetermined position with respect to the position of the pointer image GC1-2. Specifically, the guide image GC2-2 is so displayed that the intersection T1 shown in the pointer image GC1-2 is the center of the guide image GC2-2. That is, the guide image GC2-2 surrounds the intersection T1 shown in the pointer image GC1-2. The user U can grasp the positions where the one or more markers M corresponding to the position of the corner CN1-2 indicated by the pointer image GC1-2 are put by checking the guide image GC2-2.

The guide image GC2-3 is displayed at a predetermined position with respect to the position of the pointer image GC1-3. Specifically, the guide image GC2-3 is so displayed that the intersection T1 shown in the pointer image GC1-3 is the center of the guide image GC2-3. That is, the guide image GC2-3 surrounds the intersection T1 shown in the pointer image GC1-3. The user U can grasp the positions where the one or more markers M corresponding to the position of the corner CN1-3 indicated by the pointer image GC1-3 are put by checking the guide image GC2-3.

The guide image GC2-4 is displayed at a predetermined position with respect to the position of the pointer image GC1-4. Specifically, the guide image GC2-4 is so displayed that the intersection T1 shown in the pointer image GC1-4 is the center of the guide image GC2-4. That is, the guide image GC2-4 surrounds the intersection T1 shown in the pointer image GC1-4. The user U can grasp the positions where the one or more markers M corresponding to the position of the corner CN1-4 indicated by the pointer image GC1-4 are put by checking the guide image GC2-4.

The projector 1 controls the projection apparatus 16 to cause it to display a message SW1-2 on the wall surface W1. The message SW1-2 is a message that prompts the user U to put one or more markers M. Specifically, the message SW1-2 is a message that prompts the user U to put one or more markers M at the position indicated by the guide image GC2-2. That is, the user U can understand that a marker M should be put at the position indicated by the guide image GC2-2 by checking the message SW1-2.

The message SW1-2 contains a numeral NL1-2. The numeral NL1-2 is the numeral “2” representing the number of markers M to be put at the position indicated by the guide image GC2-2. That is, the user U can grasp the number of markers M that should be put at the position indicated by the guide image GC2-2 by checking the numeral NL1-2.

A plurality of messages may be displayed to prompt the user U to put one or more markers M. For example, a message corresponding to the guide image GC2-1, a message corresponding to the guide image GC2-3, and a message corresponding to the guide image GC2-4 may be displayed in addition to the message SW1-2 corresponding to the guide image GC2-2. When a plurality of messages are displayed to prompt the user U to put one or more markers M, it is preferable that the plurality of messages correspond to the plurality of guide images GC2 displayed on the wall surface W1 in a one-to-one manner.

The projector 1 displays the guide image GC2 with respect to the position of the pointer image GC1 moved based on the user U's operation relating to the first correction. The user U can properly put one or more markers M by checking the guide image GC2. When one or more markers M are put at the position indicated by the guide image GC2, the positional relationship between the one or more markers M and the corner CN1 indicated by the pointer image GC1 corresponding to the guide image GC2 is a predetermined positional relationship. Specifically, the one or more markers M are placed within a predetermined range from corner CN1. As a result, the projector 1 can capture an image of the one or more put markers M by capturing an image of the region R1, which is the region where the projection image GP1 is displayed. That is, the user U can cause the projector 1 to acquire a captured image to be used to perform the second correction without making fine adjustment of the direction in which the imaging apparatus 14 is oriented.

### 1.2. Configuration and Function of Projector

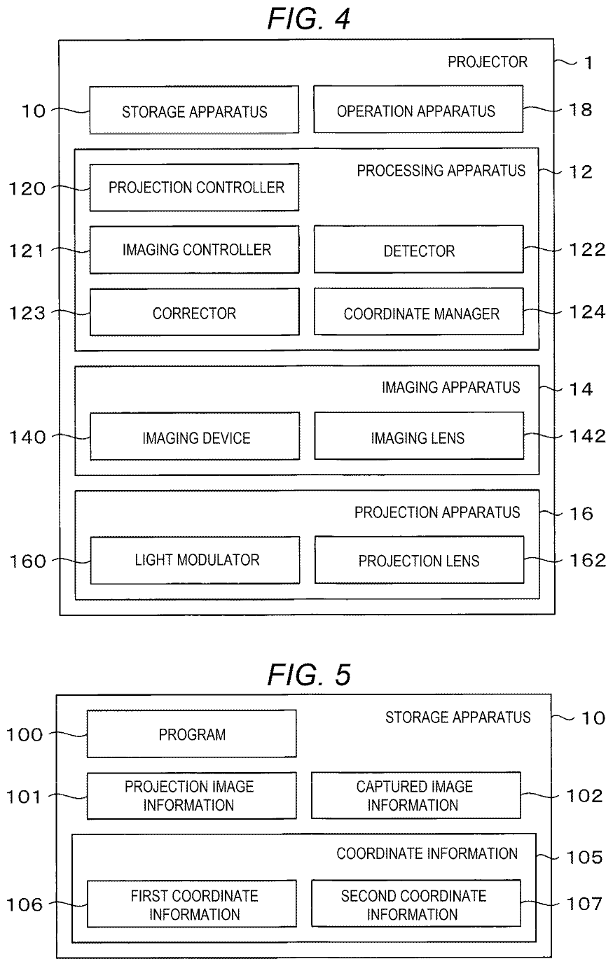

The configuration and function of the projector 1 according to the embodiment will be described below with reference to FIGS. 4 to 7.

FIG. 4 is a block diagram showing the configuration of the projector 1 according to the embodiment. The projector 1 includes a storage apparatus 10, which stores a variety of pieces of information, a processing apparatus 12, which controls the action of the projector 1, the imaging apparatus 14, which captures an image of a range containing a predetermined region of the projection surface, the projection apparatus 16, which projects the projection light onto the projection surface, and an operation apparatus 18, which accepts the user U's input operation. The processing apparatus 12 has the functions as a projection controller 120, an imaging controller 121, a detector 122, a corrector 123, and a coordinate manager 124. The imaging apparatus 14 includes the imaging device 140 and the imaging lens 142, as described above. The projection apparatus 16 includes the light source that is not shown, the light modulator 160, and the projection lens 162, as described above.

The storage apparatus 10 includes, for example, a volatile memory such as a RAM, and a nonvolatile memory such as a ROM. RAM is an abbreviation for a random access memory. ROM is an abbreviation for a read only memory.

FIG. 5 is a block diagram showing the configuration of the storage apparatus 10 according to the embodiment. The nonvolatile memory provided in the storage apparatus 10 includes a program 100, which defines the action of the projector 1, projection image information 101 representing an image to be projected from the projection apparatus 16, captured image information 102 representing the result of capture of an image of a range containing a region which is part of the projection surface and where a projection image is displayed, and coordinate information 105 representing the coordinates of each point contained in a variety of images. The nonvolatile memory provided in the storage apparatus 10 is one example of the non-transitory computer-readable storage medium. As another example of the non-transitory computer-readable storage medium, CD-ROM (Compact Disc Read only Memory) or memory card may be used.

The coordinate information 105 contains first coordinate information 106 representing the coordinates of the four corners of an image indicated by the projection image information 101 in the light modulator 160, and second coordinate information 107 representing the coordinates of a plurality of points detected from an image indicated by the captured image information 102.

The volatile memory provided in the storage apparatus 10 is used as a work area by the processing apparatus 12 when the processing apparatus 12 executes the program 100.

Part or the entirety of the storage apparatus 10 may be provided in an external storage apparatus, an external server, or any other component. Part or the entirety of the variety of pieces of information stored in the storage apparatus 10 may be stored in the storage apparatus 10 in advance, or may be acquired from the external storage apparatus, the external server, or any other component.

Referring back to FIG. 4, the processing apparatus 12 includes one or more CPUs. It is, however, noted that the processing apparatus 12 may include a programmable logic device, such as an FPGA, in place of or in addition to the CPU. The CPU is an abbreviation for a central processing unit, and FPGA is an abbreviation for a field-programmable gate array.

The processing apparatus 12 functions as the projection controller 120, the imaging controller 121, the detector 122, the corrector 123, and the coordinate manager 124 shown in FIG. 4 by causing the CPU or any other component provided in the processing apparatus 12 to execute the program 100.

The projection controller 120 projects the projection light that displays an image onto the projection surface by controlling the projection apparatus. Specifically, the projection controller 120 causes the projection apparatus to project projection light based on the projection image information 101 to display a projection image on the projection surface. In other words, the projection controller 120 causes the projection apparatus to project an image indicated by the projection image information 101 to display a projection image on the projection surface. The projection controller 120 further projects an image that assists the user U's operation onto the projection surface by controlling the projection apparatus.

In the present embodiment, the projection controller 120 controlling the projection apparatus 16 to cause it to project the projection light that displays an image onto the wall surface W1.

Specifically, the projection controller 120 causes the projection apparatus 16 to project the projection light based on the projection image information 101 to display the projection image GP1 on the wall surface W1. In other words, the projection controller 120 causes the projection apparatus 16 to project the image indicated by the projection image information 101 to display the projection image GP1 on the wall surface W1.

The projection controller 120 controls the projection apparatus 16 to cause it to display the pointer image GC1 located at the corner CN1, which the projection image GP1 has, on the wall surface W1.

The projection controller 120 further controls the projection apparatus 16 to cause it to display the guide image GC2 at a predetermined position with respect to the position of the pointer image GC1. The guide image GC2 surrounds the intersection T1 shown in the pointer image GC1.

The projection controller 120 controls the projection apparatus 16 to cause it to display a message that prompts the user U to put one or more markers M on the wall surface W1. The projection controller 120 controls the projection apparatus 16 to cause it to display the message SW1-2, which prompts the user U to put one or more markers M at the position indicated by the guide image GC2-2.

The message that prompts the user U to put one or more markers M may contain a numeral representing the number of markers M to be put. For example, the message SW1-2 contains the numeral NL1-2. In other words, the projection controller 120 controls the projection apparatus 16 to cause it to display the numeral NL1-2, which represents the number of one or more markers M to be put by the user U, on the wall surface W1. Note that the message may not contain the numeral representing the number of one or more put markers M. The projection controller 120 may display only the numeral without displaying the message.

The imaging controller 121 controls the imaging apparatus to cause it to capture an image of a range containing a region which is part of the projection surface and where a projection image is displayed. The imaging controller 121 acquires the captured image representing the result of the image capture from the imaging apparatus. The imaging controller 121 causes the storage apparatus 10 to store the captured image information 102 representing the acquired captured image.

In the present embodiment, the imaging controller 121 controls the imaging apparatus 14 to cause it to capture an image of a range containing the region R1, which is part of the wall surface W1 and where the projection image GP1 is displayed. The imaging controller 121 acquires the captured image representing the result of the image capture from the imaging apparatus 14. The imaging controller 121 causes the storage apparatus 10 to store the captured image information 102 representing the acquired captured image.

The detector 122 executes image processing on the image indicated by each of the variety of pieces of image information to detect a point contained in the image. That is, the detector 122 acquires the coordinate information 105 representing the coordinates of the detected point. The detector 122 causes the storage apparatus 10 to store the acquired coordinate information 105.

In the present embodiment, the detector 122 performs image processing on the image indicated by the captured image information 102 to detect a plurality of points contained in the image indicated by the captured image information 102. That is, the detector 122 acquires the second coordinate information 107 representing the coordinates of the plurality of points contained in the image indicated by the captured image information 102. The detector 122 causes the storage apparatus 10 to store the acquired second coordinate information 107.

The function of detecting a point may be achieved by any known image processing technology. Examples of the known image processing technology for point detection may include template matching, centroid detection, and an algorithm called “AKAZE”. No detailed technical description relating to the point detection will be made in the present specification.

The corrector 123 corrects the position and shape of a projection image displayed on the projection surface. Specifically, the corrector 123 performs the first correction based on the user U's operation.

In the present embodiment, the corrector 123 performs the first correction of correcting the projection image GP1 by changing the position of the corner CN1 of the projection image GP1 based on the user U's operation of moving the pointer image GC1. In other words, the corrector 123 updates, when the projection image GP1 is displayed, the projection image information 101 representing the image projected from the projection apparatus 16 based on the user U's operation of moving the pointer image GC1. The corrector 123 further updates the first coordinate information 106 representing the coordinates of the four corners of the image indicated by the projection image information 101 based on the user U's operation of moving the pointer image GC1.

The coordinate manager 124 carries out a variety of processes relating to the coordinates of the point detected from the image.

The coordinate manager 124 evaluates whether a plurality of points corresponding to the four corners that the image showing the region which is part of the projection surface and where the projection image is displayed has have been detected in the captured image indicated by the captured image information 102. Specifically, the coordinate manager 124 evaluates whether at least one point has been detected at each of the four corners. In the captured image indicated by the captured image information 102, when a plurality of points corresponding to the four corners that the image showing the region which is part of the projection surface and where the projection image is displayed has have not been detected, specifically, when there is a corner at which a point corresponding thereto has not been detected out of the four corners, the coordinate manager 124 controls the storage apparatus 10 to cause it to erase the second coordinate information 107 representing the coordinates of the plurality of points contained in the image indicated by the captured image information 102.

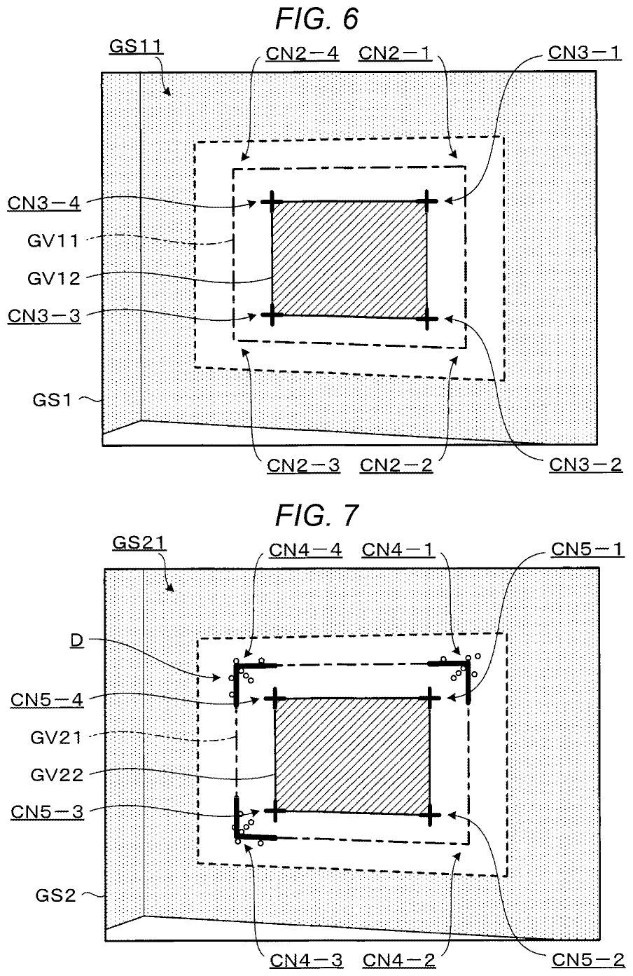

FIG. 6 is a diagrammatic view illustrating a captured image GS1. The captured image GS1 is an example of the image indicated by the captured image information 102. In the present embodiment, the processing apparatus 12 acquires the captured image GS1. The captured image GS1 is acquired when anything that explicitly shows the user U the position of the region R1 is not present on the wall surface W1, as in the case of the region R1 shown in FIG. 3.

The captured image GS1 contains an image GS11. The image GS11 represents the wall surface W1. The image GS11 contains an image GV11.

The image GV11 represents the region R1. The image GV11 has corners CN2-1, CN2-2, CN2-3, and CN2-4. The image GV11 contains an image GV12.

The image GV12 represents the projection image GP1-2. The image GV12 has corners CN3-1, CN3-2, CN3-3, and CN3-4.

The corner CN3-1 corresponds to the corner CN1-1. The corner CN3-1 further corresponds to the corner CN2-1. That is, the corner CN1-1 corresponds to the corner CN2-1.

The corner CN3-2 corresponds to the corner CN1-2. The corner CN3-2 further corresponds to the corner CN2-2. That is, the corner CN1-2 corresponds to the corner CN2-2.

The corner CN3-3 corresponds to the corner CN1-3. The corner CN3-3 further corresponds to the corner CN2-3. That is, the corner CN1-3 corresponds to the corner CN2-3.

The corner CN3-4 corresponds to the corner CN1-4. The corner CN3-4 further corresponds to the corner CN2-4. That is, the corner CN1-4 corresponds to the corner CN2-4.

As described above, since anything that explicitly shows the user U the position of the region R1 is not present on the wall surface W1, as described above, the position of the image GV11 showing the region R1 is not explicitly shown in the captured image GS1 showing the result of capture of the range containing the region R1. Therefore, when image processing is performed on the captured image GS1, a plurality of points corresponding to the corners CN2-1 to CN2-4, which the image GV11 has, are not detected. When a plurality of points corresponding to the corners CN2-1 to CN2-4 are not detected, the processing apparatus 12 controls the projection apparatus 16 to cause it to display the guide images GC2-1, GC2-2, GC2-3, and GC2-4 on the wall surface W1.

The schematic diagram shown in FIG. 7 will be described below for comparison with the captured image GS1 shown in FIG. 6. FIG. 7 is a diagrammatic view illustrating a captured image GS2. The captured image GS2 is another example of the image indicated by the captured image information 102. The captured image GS2 is acquired when marks indicating the positions of three of the four corners of the region R1, excluding the location corresponding to the corner CN1-2, are present on the wall surface W1.

The captured image GS2 contains an image GS21. The image GS21 represents the wall surface W1. The image GS21 contains an image GV21.

The image GV21 represents the region R1. The image GV21 has corners CN4-1, CN4-2, CN4-3, and CN4-4. The image GV21 has marks indicating the positions of the corners CN4-1, CN4-3, and CN4-4. The image GV21 contains an image GV22.

The image GV22 represents the projection image GP1-2. The image GV22 has corners CN5-1, CN5-2, CN5-3, and CN5-4.

The corner CN5-1 corresponds to the corner CN1-1. The corner CN5-1 further corresponds to the corner CN4-1. That is, the corner CN1-1 corresponds to the corner CN4-1.

The corner CN5-2 corresponds to the corner CN1-2. The corner CN5-2 further corresponds to the corner CN4-2. That is, the corner CN1-2 corresponds to the corner CN4-2.

The corner CN5-3 corresponds to the corner CN1-3. The corner CN5-3 further corresponds to the corner CN4-3. That is, the corner CN1-3 corresponds to the corner CN4-3.

The corner CN5-4 corresponds to the corner CN1-4. The corner CN5-4 further corresponds to the corner CN4-4. That is, the corner CN1-4 corresponds to the corner CN4-4.

In the captured image GS2, the position of the image GV21 representing the region R1 is partially indicated by marks indicating the position of the corner CN4-1, marks indicating the position of the corner CN4-3, and marks indicating the position of the corner CN4-4. When image processing is performed on the captured image GS2, at least one point D corresponding to the corner CN4-1, at least one point D corresponding to the corner CN4-3, and at least one point D corresponding to the corner CN4-4 are detected.

When there is a corner at which no point D has been detected out of the four corners of the image showing the region R1, the processing apparatus 12 controls the projection apparatus 16 to cause it to display the guide image GC2 corresponding to the pointer image GC1 indicating the position of the corner CN1 of the projection image GP1, which corresponds to the corner at which no point D has been detected. The processing apparatus 12 therefore controls the projection apparatus 16 to cause it to display the guide image GC2-2 corresponding to the pointer image GC1-2 indicating the position of the corner CN1-2 corresponding to the corner CN4-2, where no point D has been detected. That is, the user U puts one or more markers M within a predetermined range from the corner CN1 of the projection image GP1, which corresponds to the corner at which no point D has been detected out of the four corners that the image representing the region R1 has. That is, the user U can eliminate the effort of putting the markers M for the corner CN1 of the projection image GP1, which corresponds to the corner at which no point D has been detected out of the four corners that the image representing the region R1 has.

With reference back to FIG. 4, the imaging device 140 is, for example, an image sensor, such as a CCD or a CMOS device by way of example. CCD is an abbreviation for a charge coupled device, and CMOS is an abbreviation for complementary metal oxide semiconductor.

The imaging apparatus 14 captures under the control of the imaging controller 121 an image of the range containing the region which is part of the projection surface and where a projection image is displayed. The imaging apparatus 14 outputs the captured image information 102, which represents the result of the capture of an image of the range containing the region which is part of the projection surface and where the projection image is displayed, to the processing apparatus 12. In other words, the imaging apparatus 14 outputs the captured image indicated by the captured image information 102 to the processing apparatus 12.

The light modulator 160 includes, for example, one or more liquid crystal panels. The light modulator 160 may include DMDs in place of the liquid crystal panels. The light modulator 160 modulates the light emitted from the light source into the projection light that displays a projection image on the projection surface based on a signal input from the processing apparatus 12. The light source includes, for example, a halogen lamp, a xenon lamp, an ultrahigh-pressure mercury lamp, an LED, or a laser light source. LED is an abbreviation for a light emitting diode, and DMD is an abbreviation for a digital mirror device.

The projection apparatus 16 projects the projection light that displays a projection image on the projection surface under the control of the projection controller 120. In other words, the projection apparatus 16 projects an image input from the processing apparatus 12 onto the projection surface.

The operation apparatus 18 accepts input operation to be performed on the projector 1 from the user

U of the projector 1. The operation apparatus 18 includes, for example, a touch panel or operation buttons provided as part of the enclosure of the projector 1. When the operation apparatus 18 includes a touch panel, the operation apparatus 18 outputs data representing a detected touch position to the processing apparatus 12. When the operation apparatus 18 includes operation buttons, the operation apparatus 18 outputs data that identifies a pressed button to the processing apparatus 12. The operation apparatus 18 may include a receiver that receives an operation signal output from a remote control based on the user U's operation. When the operation apparatus 18 includes such a receiver, the operation apparatus 18 outputs data indicated by the operation signal received from the remote control to the processing apparatus 12. The content of the input operation to be performed on the projector 1 is thus transmitted to the processing apparatus 12.

### 1.3. Action of Projector

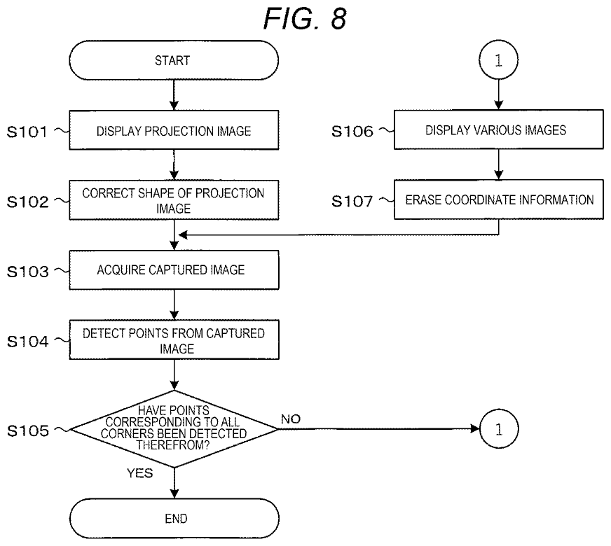

FIG. 8 is a flowchart illustrating the action of the projector 1 according to the embodiment. The series of actions shown in the flowchart of FIG. 8 starts, for example, when the projector 1 is powered on and the operation apparatus 18 accepts input operation of starting the actions from the user U.

In step S101, the projection controller 120 causes the projection apparatus 16 to project the projection light based on the projection image information 101 to display the projection image GP1-1 in the region R1 of the wall surface W1. In other words, the projection controller 120 causes the projection apparatus 16 to project an image indicated by the image information 101 to display the projection image GP1-1 in the region R1 of the wall surface W1.

The projection controller 120 controls the projection apparatus 16 to cause it to display the pointer image GC1, which is located at the corner CN1 of the projection image GP1-1, on the wall surface W1. That is, the projection controller 120 controls the projection apparatus 16 to cause it to display the pointer image GC1-1 located at the corner CN1-1, the pointer image GC1-2 located at the corner CN1-2, the pointer image GC1-3 located at the corner CN1-3, and the pointer image GC1-4 located at the corner CN1-4.

In step S102, the corrector 123 performs the first correction of correcting the shape of the projection image GP1 by changing the position of the corner CN1 of the projection image GP1 based on the user U's operation of moving the pointer image GC1. In other words, the corrector 123 updates the projection image information 101 based on the user U's operation of moving the pointer image GC1. The corrector 123 further updates the first coordinate information 106 representing the coordinates of the four corners of the image indicated by the projection image information 101 based on the user U's operation of moving the pointer image GC1. When the first correction is performed, the projection image GP1-2 is displayed on the wall surface W1.

In step S103, the imaging controller 121 controls the imaging apparatus 14 to cause it to capture an image of the range containing the region R1, which is part of the wall surface W1 and where the projection image GP1 is displayed. The imaging controller 121 acquires the captured image representing the result of the image capture from the imaging apparatus 14. The imaging controller 121 causes the storage apparatus 10 to store the captured image information 102 representing the acquired captured image.

Note that the series of actions shown in the flowchart of FIG. 8 will be described below on the assumption that the captured image GS1 is acquired in step S103.

In step S104, the detector 122 performs image processing on the captured image GS1 indicated by the captured image information 102 to detect the plurality of points D contained in the captured image GS1. That is, the detector 122 acquires the second coordinate information 107 representing the coordinates of the plurality of points D contained in the captured image GS1. The detector 122 causes the storage apparatus 10 to store the acquired second coordinate information 107.

In step S105, the coordinate manager 124 evaluates whether a plurality of points D corresponding to the corners CN2-1 to CN2-4, which the image GV11 showing the region R1, which is part of the wall surface W1 and where the projection image GP1 is displayed, has, have been detected in the captured image GS1 indicated by the captured image information 102. Specifically, the coordinate manager 124 evaluates whether at least one point D has been detected at each of the corners CN2-1 to CN2-4. In the captured image GS1, when a plurality of points D corresponding to the corners CN2-1 to CN2-4, which the image GV11 showing the region R1 has, have been detected, specifically, when at least one point D has been detected at each of the corners CN2-1 to CN2-4, that is, when the result of step S105 is YES, the processing apparatus 12 including the coordinate manager 124 terminates the series of actions shown in the flowchart of FIG. 8. In the captured image GS1, when a plurality of points D corresponding to the corners CN2-1 to CN2-4, which the image GV11 showing the region R1 has, are not detected, specifically, when there is a corner at which a point D corresponding thereto has not been detected out of the corners CN2-1 to CN2-4, that is, when the result of step S105 is NO, the coordinate manager 124 proceeds to the process in step S106.

When image processing is performed on the captured image GS1, no point D is detected, as described above. The result of the evaluation in step S105 is therefore NO.

In step S106, the projection controller 120 controls the projection apparatus 16 to cause it to display the guide image GC2 at a predetermined position with respect to the position of the pointer image GC1. Specifically, the projection controller 120 causes the projection apparatus 16 to display the guide image GC2 corresponding to the pointer image GC1 indicating the position of the corner CN1 of the projection image GP1, which corresponds to the corner at which no point D has been detected out of the corners CN2-1 to CN2-4, based on the second coordinate information 107. That is, the projection controller 120 controls the projection apparatus 16 to cause it to display the guide images GC2-1, GC2-2, GC2-3, and GC2-4 on the wall surface W1. The guide image GC2-1 is displayed at a predetermined position with respect to the position of the pointer image GC1-1. The guide image GC2-2 is displayed at a predetermined position with respect to the position of the pointer image GC1-2. The guide image GC2-3 is displayed at a predetermined position with respect to the position of the pointer image GC1-3. The guide image GC2-4 is displayed at a predetermined position with respect to the position of the pointer image GC1-4.

The projection controller 120 controls the projection apparatus 16 to cause it to display a message that prompts the user U to put one or more markers M on the wall surface W1. Specifically, the projection controller 120 controls the projection apparatus 16 to cause it to display the message SW1-2, which prompts the user U to put one or more markers M at the position indicated by the guide image GC2-2. The message SW1-2 contains the numeral NL1-2. In other words, the projection controller 120 controls the projection apparatus 16 to cause it to display the numeral NL1-2, which represents the number of one or more markers M to be put by the user U, on the wall surface W1.

In step S107, the coordinate manager 124 controls the storage apparatus 10 to erase the second coordinate information 107.

When the guide images GC2-1 to GC2-4 are displayed in step S106, the user U puts one or more markers M at the position indicated by each of the guide images GC2-1 to GC2-4. That is, the user U puts one or more markers M at the position indicated by the guide image GC2-1, one or more markers M at the position indicated by the guide image GC2-2, one or more markers M at the position indicated by the guide image GC2-3, and one or more markers M at the position indicated by the guide image GC2-4. When the user U puts one or more markers M at the position indicated by each of the guide images GC2-1 to GC2-4, the processing apparatus 12 acquires a captured image representing the result of capture of an image of the wall surface W1 on which the plurality of markers M are put, specifically, the range containing the region R1 of the wall surface W1 by carrying out the process in step S103. The captured image includes a plurality of images representing the markers M put on the wall surface W1. The processing apparatus 12 detects, from the captured image, a plurality of points D corresponding to the plurality of images showing the markers M put on the wall surface W1 by carrying out the process in step S104. That is, the processing apparatus 12 can detect at least one point D at each of the four corners of the image showing the region R1 by performing image processing on the captured image. The projector 1 can thus perform the second correction by using the captured image.

As described above, according to the embodiment, the projector 1 displays the guide image GC2 with respect to the position of the pointer image GC1 moved based on the user U's operation relating to the first correction. That is, the user U can put one or more markers M at proper positions by checking the guide image GC2. When one or more markers M are put at the position indicated by the guide image GC2, the one or more markers M are disposed within a predetermined range from the corner CN1, which is a corner of the projection image GP1 and indicated by the pointer image GC1 corresponding to the guide image GC2. As a result, the projector 1 can capture an image of the one or more put markers M by capturing an image of the region R1, which is the region where the projection image GP1 is displayed. The user U can therefore cause the projector 1 to acquire a captured image to be used to perform the second correction without making fine adjustment of the direction in which the imaging apparatus 14 is oriented.

According to the embodiment, the projector 1 controls the projection apparatus 16 to cause it to display the message SW1-2, which prompts the user U to put one or more markers M on the wall surface W1. That is, the user U can understand that a marker M should be put at the position indicated by the guide image GC2-2 by checking the message SW1-2. The message SW1-2 contains the number NL1-2 indicating the number of markers M to be put at the position indicated by the guide image GC2-2. That is, the user U can grasp the number of markers M that should be put at the position indicated by the guide image GC2-2 by checking the numeral NL1-2.

As described above, the display method according to the embodiment includes displaying the projection image GP1 on the wall surface W1 by controlling the projection apparatus 16, displaying the pointer image GC1 located at a corner of the projection image GP1 by controlling the projection apparatus 16, performing the first correction of correcting the shape of the projection image GP1 by changing the position of the corner of the projection image GP1 based on the user U's operation of moving the pointer image GC1, and displaying the guide image GC2, which indicates the position where one or more markers M are put by the user U, by controlling the projection apparatus 16 at a predetermined position on the wall surface W1 with respect to the position of the pointer image GC1 moved based on the user U's operation.

The projector 1 according to the embodiment includes the processing apparatus 12, and the processing apparatus 12 controls the projection apparatus 16 to cause it to display the projection image GP1 on the wall surface W1, controls the projection apparatus 16 to cause it to display the pointer image GC1 located at a corner of the projection image GP1, performs the first correction of correcting the shape of the projection image GP1 by changing the position of the corner of the projection image GP1 based on the user U's operation of moving the pointer image GC1, and displays the guide image GC2, which indicates the position where one or more markers M are put by the user U, by controlling the projection apparatus 16 at a predetermined position on the wall surface W1 with respect to the position of the pointer image GC1 moved based on the user U's operation.

The program 100 according to the embodiment causes the processing apparatus 12 to control the projection apparatus 16 to cause it to display the projection image GP1 on the wall surface W1, control the projection apparatus 16 to cause it to display the pointer image GC1 located at a corner of the projection image GP1 has, perform the first correction of correcting the shape of the projection image GP1 by changing the position of the corner of the projection image GP1 based on the user U's operation of moving the pointer image GC1, and display the guide image GC2, which indicates the position where one or more markers M are put by the user U, by controlling the projection apparatus 16 at a predetermined position on the wall surface W1 with respect to the position of the pointer image GC1 moved based on the user U's operation.

That is, the user U can put one or more markers M at proper positions by checking the guide image GC2. When one or more markers M are put at the position indicated by the guide image GC2, the one or more markers M are disposed within a predetermined range from the corner CN1, which is a corner of the projection image GP1 and indicated by the pointer image GC1 corresponding to the guide image GC2. As a result, the projector 1 can capture an image of the one or more put markers M by capturing an image of the region R1, which is the region where the projection image GP1 is displayed. The user U can therefore cause the projector 1 to acquire the captured image without making fine adjustment of the direction in which the imaging apparatus 14 is oriented.

In the embodiment, the projector 1 is an example of the “information processing apparatus”, the program 100 is an example of the “program”, the processing apparatus 12 is an example of the “ processing apparatus”, the projection apparatus 16 is an example of the “projection apparatus”, the wall surface W1 is an example of the “projection surface”, the projection image GP1 is an example of the “projection image”, the pointer image GC1 is an example of the “pointer image”, the user U is an example of the “user”, the marker M is an example of the “marker”, the one or more markers M are an example of the “one or more markers”, and the guide image GC2 is an example of the “guide image”. “The corner of the projection image” and “the corner of the projection image” are each the corner CN1 by way of example. More specifically, the “pointer image” is the pointer image GC1-2 by way of example. The “guide image” is the guide image GC2-2 by way of example. “The corner of the projection image” and “the corner of the projection image” are each the corner CN1-2 by way of example.

In the display according to the embodiment, the pointer image GC1 has the lines L1 and L2, and the guide image GC2 has a rectangular frame that surrounds the intersection T1, where the lines L1 and L2 intersect with each other.

That is, the projector 1 can more clearly indicate the positions where the one or more markers M are put. The user U can thus put a marker M more accurately.

In the embodiment, the line L1 is an example of the “first line”, the line L2 is an example of the “second line”, and the intersection T1 is an example of the “intersection”. “The figure that surrounds the intersection” is the rectangular frame line by way of example.

The display method according to the embodiment further includes acquiring the captured image GS1 representing the result of the capture of an image of the range containing the region R1, where the projection image GP1 is displayed, and detecting a plurality of points D corresponding in a one-to-one manner to the four corners of the image GV11 representing the region R1 contained in the captured image GS1 by performing image processing on the captured image GS1, and when there is a corner at which no point D has been detected out of the four corners of the image GV11, the pointer image GC1 is located at the corner of the projection image GP1, which corresponds to the corner at which no point D has been detected.

That is, the projector 1 displays the guide image GC2 corresponding to the pointer image GC1 indicating the position of the corner CN1 of the projection image GP1, which corresponds to the corner where no point D has been detected out of the four corners that the image GV11 showing the region R1 has. The user U therefore only needs to put one or more markers M at necessary locations, and can eliminate the effort of putting a marker M more than necessary.

In the embodiment, the region R1 is an example of the “display region”, the point D is an example of the “characteristic point”, and the plurality of points D are an example of “a plurality of points”. The “captured image” is either of the captured images GS1 and GS2 by way of example. The “first image” is either of the images GV11 and GV21 by way of example. “The four corners that the first image has” are either set of the corners CN2-1 to CN2-4 and CN4-1 to CN4-4 by way of example.

In the display method according to the embodiment, the displaying the guide image GC2-2 includes displaying the message SW1-2, which prompts the user U to put one or more markers M.

The user U can thus understand that a marker M should be put at the position indicated by the guide image GC2-2 by checking the message SW1-2.

In the embodiment, the message SW1-2 is an example of the “message”.

In the display method according to the embodiment, the displaying the guide image GC2-2 includes displaying the numeral NL1-2 representing the number of one or more markers M to be put by the user U.

The user U can thus grasp the number of markers M that should be put at the position indicated by the guide image GC2-2 by checking the numeral NL1-2.

Note in the embodiment that the numeral NL1-2 is an example of the “numeral”.

### 2. Variations

The embodiment described above can be varied in a variety of manners. Specific aspects of the variations will be presented below by way of example. Two or more aspects arbitrarily selected from those presented below by way of example may be combined with each other as appropriate to the extent that the selected aspects do not contradict each other. In the variations presented below by way of example, an element providing the same effect and having the same function as the element in the embodiment described above has the same reference character used in the above description, and no detailed description of the same element will be made as appropriate.

### 2.1. Variation 1

The aforementioned embodiment has been described with reference to the case where the projector 1 implements the display method according to the present disclosure, but the present disclosure is not limited to such an aspect. For example, the display method according to the present disclosure may be implemented in a multi-projection system including two projectors and an information processing apparatus such as a computer. Instead of including two projectors and an information processing apparatus, the display method according to the present disclosure may be implemented in a system including a projector having the function of the information processing apparatus and a projector not having the function of the information processing apparatus.

For example, when the display method according to the present disclosure is implemented in a projection system including a projector and an information processing apparatus including a display panel, such as a laptop computer, the message that prompts the user U to put one or more markers M may be displayed on the display panel.

Similarly, the numeral representing the number of one or more markers M to be put by the user U may be displayed on the display panel. When the projection system that implements the display method according to the present disclosure includes a display panel, the projection system may control the display panel to cause it to display an image indicating the position of a point detected from a captured image through image processing with the image superimposed on the captured image. The user U can thus check whether a point has been properly detected from the captured image.

### 2.2. Variation 2

The aforementioned embodiment and variation have been described by way of example with reference to the case where the guide image GC2 is an image having a rectangular frame line, but the present disclosure is not limited to such an aspect. The guide image may be an image having a circular frame line, a diamond-shaped frame line, or a pentagonal frame line. The guide image may be an image having a polygonal frame line other than a rectangular frame line.

The figure that the guide image has may not be a figure that seamlessly surrounds the intersection that the pointer image has. The figure that the guide image has may be a partly cut figure, for example, what is called a Landolt ring.

### 2.3. Variation 3

The aforementioned embodiment and variations have been described by way of example with reference to the case where the numeral NL1-2, which represents the number of markers M to be put at the position indicated by the guide image GC2-2, is displayed. For example, when a plurality of guide images GC2 are displayed, a numeral representing the total number of markers M to be put at the positions indicated by the plurality of guide images GC2 may be displayed. The numeral representing the total number may be displayed along with the numeral representing the number of markers M to be put at the position indicated by one of the plurality of guide images GC2.

### 2.4. Variation 4

Part or the entirety of the control performed by the projector 1 may be performed by the processing apparatus 12. Part or the entirety of the control performed by the processing apparatus 12 may be performed by the projector 1.

### 3. Additional Remarks

A summary of the present disclosure will be described below as additional remarks.

### 3.1. Additional Remark 1

A display method including displaying a projection image on a projection surface by controlling a projection apparatus, displaying a pointer image located at a corner of the projection image by controlling the projection apparatus, performing first correction of correcting the shape of the projection image by changing the position of the corner of the projection image based on a user's operation of moving the pointer image, and displaying a guide image indicating the positions where one or more markers are put by the user by controlling the projection apparatus at a predetermined position on the projection surface with respect to the position of the pointer image moved based on the user's operation.

That is, the user can put one or more markers at proper positions by checking the guide image. When one or more markers are put at the position indicated by the guide image, the one or more markers are disposed within a predetermined range from the corner of the projection image that is indicated by the pointer image corresponding to the guide image. As a result, a projector or a projection system that implements the display method described in the additional remark 1 can capture an image of the one or more put markers by capturing an image of a display region that is the region where the projection image is displayed. The user can therefore cause the projector or the projection system that implements the display method described in the additional remark 1 to acquire a captured image without making fine adjustment of the direction in which an imaging apparatus is oriented.

### 3.2. Additional Remark 2

The display method described in the additional remark 1, in which the pointer image has first and second lines, and the guide image has a figure that surrounds the intersection where the first and second lines intersect with each other.

That is, the projector or the projection system that implements the display method described in the additional remark 2 can more clearly show the positions where the one or more markers are put. The user can thus put the markers more accurately.

### 3.3. Additional Remark 3

The display method described in the additional remark 1 or 2, which further includes acquiring a captured image representing the result of capture of an image of a range containing a display region where the projection image is displayed, and detecting a plurality of characteristic points corresponding in a one-to-one manner to the four corners of a first image showing the display region contained in the captured image by performing image processing on the captured image, and in which when there is a corner at which none of the characteristic points has been detected out of the four corners of the first image, the pointer image is located at the corner of projection image that corresponds to the corner at which none of the characteristic points has been detected.

That is, the projector or the projection system that implements the display method described in the additional remark 3 displays a guide image corresponding to a pointer image indicating the position of the corner of the projection image that corresponds to the corner where none of the characteristic points has been detected out of the four corners that the first image showing the display region has. The user therefore only needs to put one or more markers at necessary locations, and can eliminate the effort of putting a marker more than necessary.

### 3.4. Additional Remark 4

The display method described in any one of the additional remarks 1 to 3, in which the displaying the guide image includes displaying a message that prompts the user to put the one or more markers.

The user can thus understand that a marker should be put at the position indicated by the guide image by checking the message.

### 3.5. Additional Remark 5

The display method described in any one of the additional remarks 1 to 4, in which the displaying the guide image includes displaying a numeral representing the number of locations where the one or more markers are put by the user.

The user can thus grasp the number of markers that should be put at the position indicated by the guide image by checking the numeral.

3.6. Additional Remark 6

An information processing apparatus including a processing apparatus, the processing apparatus controlling a projection apparatus to cause it to display a projection image on a projection surface, controlling the projection apparatus to cause it to display a pointer image located at a corner of the projection image, performing first correction of correcting the shape of the projection image by changing the position of the corner of the projection image based on a user's operation of moving the pointer image, and controlling the projection apparatus to cause it to display a guide image indicating the positions where one or more markers are put by the user at a predetermined position on the projection surface with respect to the position of the pointer image moved based on the user's operation.

That is, the user can put one or more markers at proper positions by checking the guide image. When one or more markers are put at the position indicated by the guide image, the one or more markers are disposed within a predetermined range from the corner of the projection image that is indicated by the pointer image corresponding to the guide image. As a result, a projection system including the information processing apparatus described in the additional remark 6 can capture an image of the one or more put markers by capturing an image of a display region that is the region where the projection image is displayed. The user can therefore cause the projection system including the information processing apparatus described in the additional remark 6 to acquire a captured image without making fine adjustment of the direction in which an imaging apparatus is oriented.

### 3.7. Additional Remark 7

A program that causes a processing apparatus to control a projection apparatus to cause it to display a projection image on a projection surface, control a projection apparatus to cause it to display a pointer image located at a corner of the projection image, perform first correction of correcting the shape of the projection image by changing the position of the corner of the projection image based on a user's operation of moving the pointer image, and control the projection apparatus to cause it to display a guide image indicating the positions where one or more markers are put by the user at a predetermined position on the projection surface with respect to the position of the pointer image moved based on the user's operation.

That is, the user can put one or more markers at proper positions by checking the guide image. When one or more markers are put at the position indicated by the guide image, the one or more markers are disposed within a predetermined range from the corner of the projection image that is indicated by the pointer image corresponding to the guide image. As a result, a projector or a projection system that operates in accordance with the program described in the additional remark 7 can capture an image of the one or more put markers by capturing an image of a display region that is the region where the projection image is displayed. The user can therefore cause the projector or the projection system that operates in accordance with the program described in the additional remark 7 to acquire a captured image without making fine adjustment of the direction in which an imaging apparatus is oriented.

What is claimed is:

1. A display method comprising:
displaying a projection image on a projection surface by controlling a projection apparatus;
displaying a pointer image located at a corner of the projection image by controlling the projection apparatus;
performing first correction of correcting a shape of the projection image by changing a position of the corner of the projection image based on a user's operation of moving the pointer image; and
displaying a guide image indicating positions where one or more markers are put by the user by controlling the projection apparatus at a predetermined position on the projection surface with respect to the position of the pointer image moved based on the user's operation.

2. The display method according to claim 1,
wherein the pointer image has first and second lines, and
the guide image has a figure that surrounds an intersection where the first and second lines intersect with each other.

3. The display method according to claim 1 further comprising:
acquiring a captured image representing a result of capture of an image of a range containing a display region where the projection image is displayed, and
detecting a plurality of characteristic points corresponding in a one-to-one manner to four corners of a first image showing the display region contained in the captured image by performing image processing on the captured image,
wherein when there is a corner at which none of the characteristic points is detected out of the four corners of the first image, the pointer image is located at a corner of projection image that corresponds to the corner at which none of the characteristic points is detected.

4. The display method according to claim 1,
wherein the displaying the guide image includes displaying a message that prompts the user to put the one or more markers.

5. The display method according to claim 1,
wherein the displaying the guide image includes displaying a numeral representing the number of locations where the one or more markers are put by the user.

6. An information processing apparatus comprising
a processing apparatus,
wherein the processing apparatus
controls a projection apparatus to cause the projection apparatus to display a projection image on a projection surface,
controls the projection apparatus to cause the projection apparatus to display a pointer image located at a corner of the projection image,
performs first correction of correcting a shape of the projection image by changing a position of the corner of the projection image based on a user's operation of moving the pointer image, and
controls the projection apparatus to cause the projection apparatus to display a guide image indicating positions where one or more markers are put by the user at a predetermined position on the projection surface with respect to a position of the pointer image moved based on the user's operation.

7. A non-transitory computer-readable storage medium storing a program that causes a processing apparatus to
control a projection apparatus to cause the projection apparatus to display a projection image on a projection surface,
control a projection apparatus to cause the projection apparatus to display a pointer image located at a corner of the projection image,
perform first correction of correcting a shape of the projection image by changing a position of the corner of the projection image based on a user's operation of moving the pointer image, and
control the projection apparatus to cause the projection apparatus to display a guide image indicating positions where one or more markers are put by the user at a predetermined position on the projection surface with respect to a position of the pointer image moved based on the user's operation.
